(19) United States
(12) Patent Application Publication
(10) Pub. No.: US 2014/0177773 A1
(43) Pub. Date: Jun. 26, 2014

(54) CONTROL ROD DRIVE APPARATUS UTILIZING ALLOYS WITH LOW TO ZERO COBALT CONTENT

(71) Applicants: Maria Christine KRETZING, Wilmington, NC (US); Catherine Procik DULKA, Exton, PA (US); Erol CAGLARCAN, Wilmington, NC (US)

(72) Inventors: Maria Christine KRETZING, Wilmington, NC (US); Catherine Procik DULKA, Exton, PA (US); Erol CAGLARCAN, Wilmington, NC (US)

(21) Appl. No.: 13/721,851

(22) Filed: Dec. 20, 2012

(51) Int. Cl. G21C 7/16

(52) U.S. Cl. CPC G21C 7/16
USPC 376/230

(57) ABSTRACT

A control rod drive apparatus may include a cylindrical housing structure having a proximal end and an opposing distal end. A drive assembly including a drive piston and an index tube may be arranged within the cylindrical housing structure. A flange may be connected to the proximal end of the cylindrical housing structure and may define a vacancy therein. A check valve ball may be disposed within the vacancy, wherein the vacancy may be configured to facilitate a displacement of the check valve ball between an open position and a closed position. The control rod drive apparatus may also include a collet assembly within the cylindrical housing structure. The check valve ball and/or the collet assembly may be made of an alloy having less than 2% cobalt by weight.

### BACKGROUND

1. Field

The present disclosure relates to control rod drive mechanisms of a nuclear reactor.

2. Description of Related Art

Control rod drives are used to insert/remove control rods into/from the reactor core to control the neutron flux and the resulting rate of fission of the nuclear fuel. The rate of fission of the nuclear fuel affects the thermal power of the reactor, the amount of steam produced, and thus the electricity generated. Conventional control rod drives include components made of cobalt-based alloys. Such components include check valve balls and collet structures. Cobalt-based alloys (e.g., Stellite) are conventionally used in control rod drives because of their desirable levels of hardness and resistance to wear and corrosion.

However, the presence of relatively large amounts (e.g., 51% by weight) of cobalt in conventional alloys increases exposure concerns with regard to plant personnel. In particular, the reactor environment causes the stable cobalt-59 in the conventional alloys to be converted to radioactive cobalt-60, which contributes to higher radiation levels and also increases the cost of decontamination.

### SUMMARY

A control rod drive apparatus may include a cylindrical housing structure having a proximal end and an opposing distal end. A drive assembly may be arranged within the cylindrical housing structure. The drive assembly may include a drive piston and an index tube. A flange may be connected to the proximal end of the cylindrical housing structure. The flange may define a vacancy therein. A check valve ball may be disposed within the vacancy defined by the flange. The vacancy may be configured to facilitate a displacement of the check valve ball between an open position and a closed position. The open position may allow a first flow in a first direction to facilitate movement of the drive piston toward the distal end of the cylindrical housing structure, while the closed position may halt a second flow in an opposite second direction. The check valve ball may be made of an alloy having less than 2% cobalt by weight. The control rod drive apparatus may also include a collet assembly within the cylindrical housing structure, wherein the collet assembly may be made of an alloy having less than 2% cobalt by weight. As a result of the lower cobalt content alloy, less radioactive cobalt-60 may be generated from the stable cobalt-59 of the alloy by the reactor environment, thereby decreasing the exposure to plant personnel.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a fragmented, cross-sectional view of a control rod drive apparatus according to a non-limiting embodiment.

FIG. 2 is a side, cut-away view of a collet assembly that may be used in the control rod drive apparatus according to a non-limiting embodiment.

FIG. 3 is a plan view of a collet assembly that may be used in the control rod drive apparatus according to a non-limiting embodiment.

### DETAILED DESCRIPTION

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

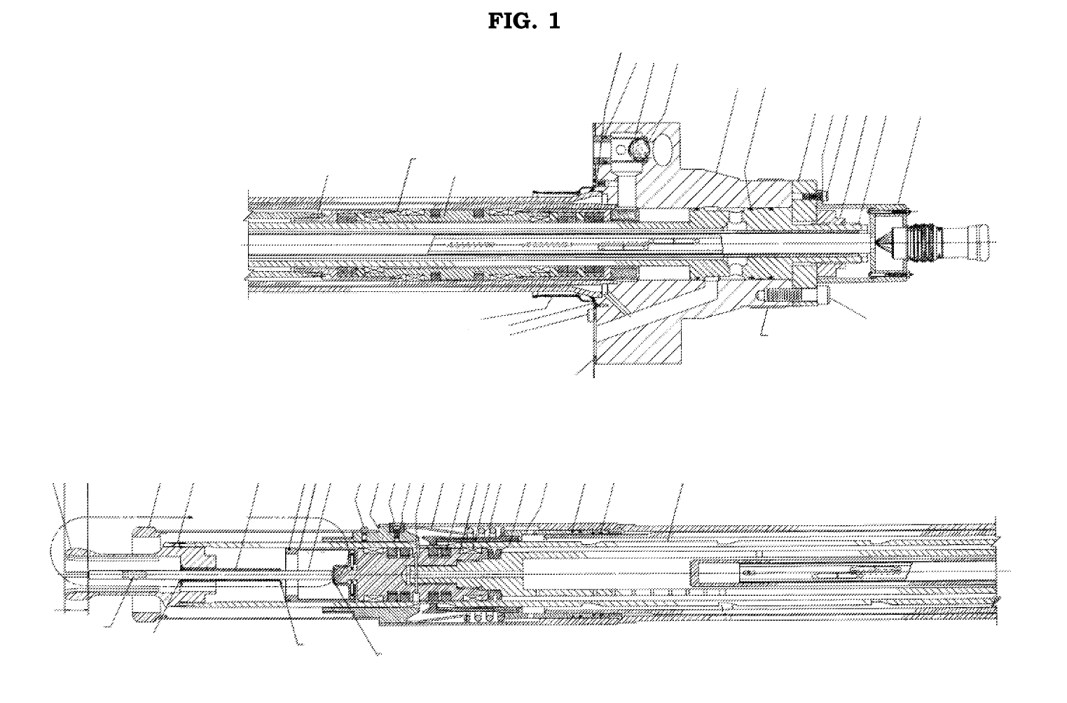

FIG. 1 is a fragmented, cross-sectional view of a control rod drive apparatus according to a non-limiting embodiment. The view of the control rod drive apparatus is merely broken into two fragments to enable viewing on a single page. That being said, it should be understood that the control rod drive apparatus is a united elongated structure in actuality. Referring to FIG. 1, the control rod drive apparatus 100 includes a cylindrical housing structure 102 including a proximal end and an opposing distal end. The proximal end of the cylindrical housing structure 102 is illustrated in the upper fragment portion of FIG. 1, while the distal end of the cylindrical housing structure 102 is illustrated in the lower fragment portion of FIG. 1. When installed in a reactor, a control rod is secured to the distal end of the control rod drive apparatus 100.

A drive assembly is arranged within the cylindrical housing structure 102. The drive assembly includes a drive piston 104 and an index tube 106. The drive piston 104 and the index tube 106 may be arranged concentrically within the cylindrical housing structure 102. A flange 108 is connected to the proximal end of the cylindrical housing structure 102. The flange 108 defines a vacancy 110 therein. A check valve ball 112 is disposed within the vacancy 110 defined by the flange 108. The vacancy 110 is configured to facilitate a displacement of the check valve ball 112 between an open position and a closed position. The open position allows a first flow in a first direction to facilitate movement of the drive piston 104 toward the distal end of the cylindrical housing structure 102, while the closed position halts a second flow in an opposite second direction. The check valve ball 112 may be made of an alloy having less than 2% cobalt by weight. For example, the alloy may include less than 0.5% cobalt by weight.

The control rod drive apparatus 100 may further include a collet assembly 114 within the cylindrical housing structure 102. The collet assembly 114 may surround the index tube 106 of the drive assembly. The collet assembly 114 includes collet fingers 116 mounted on a collet piston 118. The collet fingers 116 may be configured to engage with the index tube 106. The entire collet assembly 114 or just a portion thereof (e.g., collet fingers 116) may be made of the alloy having less than 2% cobalt by weight. For example, the alloy may include less than 0.5% cobalt by weight.

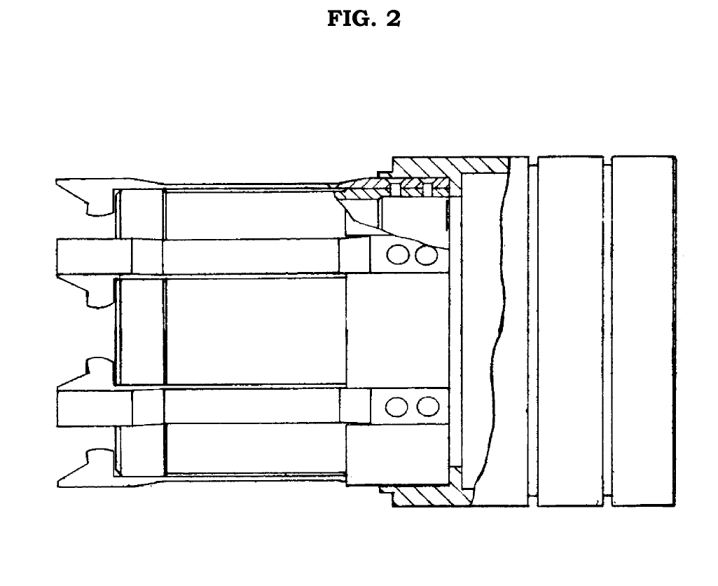

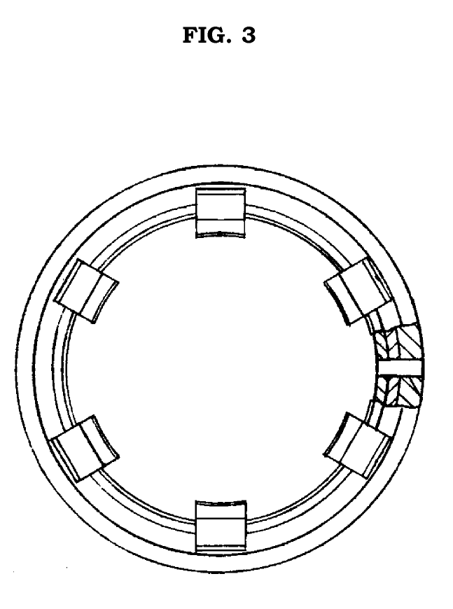

FIG. 2 is a side, cut-away view of a collet assembly that may be used in the control rod drive apparatus according to a non-limiting embodiment. FIG. 3 is a plan view of a collet assembly that may be used in the control rod drive apparatus according to a non-limiting embodiment. Referring to FIGS. 2-3, the collet assembly 114 includes a plurality of collet fingers 116 arranged around the periphery of the collet piston 118. Although the collet assembly 114 is shown as having six collet fingers 116, it should be understood that example embodiments are not limited thereto. Each of the collet fingers 116 includes a tip portion that extends inward toward the center of the collet assembly 114. When installed in the control rod drive apparatus 100, the tip portions of the collet fingers 116 will engage/disengage with grooves on the index tube 106 as the collet assembly 114 moves in the intended axial direction.

Table I below shows the materials considered for the alloy discussed herein.

| | Composition (wt. %) | | | | | | | | | | | Hardness | Melt Pt | |
|---|---|---|---|---|---|---|---|---|---|---|---|---|---|---|
| Alloys | Co | Ni | C | Mn | Cr | Mo | B | Si | Fe | W | Other | Rockwell C | deg F. | Sp Grav |
| Stellite 6 | bal | 0-3 | 1.2 | 1 | 28 | | | 1.1 | 0-3 | 4.5 | | 40-45 | 2340 | |
| Colmonoy 62 | | bal | 0.6 | | 15 | | 2.8 | 4.5 | 4 | | | 56-61 | 1875 | |
| Colmonoy 84 | | bal | 1.1 | | 29 | | 1.3 | 2.0 | 2 | 7.5 | | 45 | 2250 | 8.3 |
| PTA | | | | | | | | | | | | | | |
| Colmonoy 5 | | bal | 0.6 | | 12 | | 2.5 | 5 | 3.7 | | | 45-50 | 1880 | |
| Colmonoy 5 | | bal | 0.7 | | 14.3 | | 1.6 | 4.8 | 4.9 | | | SP: 40s, | 2000 | |
| PTA | | | | | | | | | | | | DP: 47-52 | | |
| Norem 01 | | 4 | 1 | 9 | 25 | 2 | | 3 | bal | | 0.1 N | 41 | | |
| Norem 02 | 0.05 | 4 | 1.25 | 4.5 | 25 | 2 | 0.002 | 3.3 | bal | | 0.16 N, | 36-42, | | |
| | | | | | | | | | | | 0.01 S, | Typically | | |
| | | | | | | | | | | | 0.018 P, | 36 | | |
| | | | | | | | | | | | 0.02 O | | | |
| Norem 04 | | 8 | 1 | 12 | 24 | 2 | | 5 | bal | | | 39-45 | | |
| Nucalloy 453 | | bal | 0.85 | | 10 | | 0.5 | 5.3 | 3 | 2 | | 43 | | |
| Nucalloy 488 | | bal | 0.3 | | 17.5 | | 1 | 6.8 | 5.5 | 1 | 0.7 Sn | 45 | | |
| Tribaloy T-700 | 1.5 | bal | 0-0.08 | | 15.5 | 32.5 | | 3.4 | 0-3 | | | 45 | 2270 | |
| Deloro 40 | 0-1.5 | bal | 0.1-0.3 | | 7.5 | | 1.7-2.3 | 3.5 | 2.5 | | | 38-42 | 1760 | 8.22 |
| Deloro 45 | | bal | 0.35 | | 9 | | 1.9 | 3.7 | 2.5 | | | 45 | | |
| Deloro 50 | | bal | 0.45 | | 10.5 | | 1.8-2.3 | 4 | 3-4 | | | 48-52 | 1782 | 8.14 |
| Delcrome 910 | | | 2.5 | 0.9 | 25 | 3 | | 0.4 | bal | | | 52 | | |
| Everit 50 | | | 2.5 | <1 | 25 | 3.2 | | <0.5 | bal | | | 47-53 | | |
| Tristelle 5183 | 0.2 | 10 | 2 | | 21 | | | 5 | bal | | 8 Nb | 41 | 2192 | 7.5 |

Table II below shows a more focused group of the materials considered for the alloy discussed herein.

| | Composition (wt. %) | | | | | | | | | | |
|---|---|---|---|---|---|---|---|---|---|---|---|
| Alloys | Co | Ni | C | Mn | Cr | Mo | B | Si | Fe | W | Other |
| Stellite 6 | bal | 3 | 0.9-1.4 | 1 | 26.0-31.0 | — | — | 0.4-1.5 | 3 | 3.5-5.5 | — |
| Colmonoy 84 | 0.25 | bal | 0.8-1.4 | — | 26.0-32.0 | — | 1.0-2.0 | 1.8-2.7 | 3 | 5.0-10.0 | — |
| PTA | | | | | | | | | | | |
| Colmonoy 5 | 0.25 | bal | 0.4-0.8 | — | 10.0-15.0 | — | 1.0-3.0 | 3.5-5.5 | 3.5-5.5 | — | — |
| PTA | | | | | | | | | | | |
| Norem 02 | 0.05 | 3.7-4.2 | 1.1-1.35 | 4.0-5.0 | 24.0-26.0 | 1.8-2.2 | 0.002 | 3.1-3.5 | bal | — | — |
| Nucalloy 453 | — | bal | 0.7-0.95 | — | 9.0-11.0 | | 0.4-0.6 | 4.8-5.8 | 2.0-4.0 | 1.5-2.5 | |
| Tristelle 5183 | 0.2 | 8.5-10.5 | 1.8-2.2 | 0.5 | 19.0-22.0 | 0.3 | | 4.5-5.25 | bal | — | 6.5-8.0 |
| | | | | | | | | | | | Nb |

The alloy used to make the check valve ball 112 and/or the collet assembly 114 may have a hardness of at least 30 on a hardness Rockwell C (HRC) scale and a melting point of at least 1700 degrees F. The alloy may be nickel-based or iron-based. Additionally, the alloy may include boron. Furthermore, the alloy may include at least 2% silicon by weight.

The alloy may be Colmonoy, Nucalloy, Tristelle, or Norem, although example embodiments are not limited thereto. For instance, the Colmonoy may be Colmonoy 5 or Colmonoy 84. The Nucalloy may be Nucalloy 453. The Tristelle may be Tristelle 5183. The Norem may be Norem 2. Furthermore, although the examples herein were primarily discussed in connection with the check valve ball 112 and the collet assembly 114, it should be understood that the alloys herein may also be used to make other components of the control rod drive apparatus 100. As a result of the low to zero cobalt content alloys discussed herein, radiation levels stemming from cobalt-60 may be decreased.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. A control rod drive apparatus, comprising:
a cylindrical housing structure including a proximal end and an opposing distal end;
a drive assembly within the cylindrical housing structure, the drive assembly including a drive piston and an index tube;
a flange connected to the proximal end of the cylindrical housing structure, the flange defining a vacancy therein; and
a check valve ball disposed within the vacancy defined by the flange, the vacancy configured to facilitate a displacement of the check valve ball between an open position which allows a first flow in a first direction to facilitate movement of the drive piston toward the distal end of the cylindrical housing structure and a closed position which halts a second flow in an opposite second direction, the check valve ball being made of an alloy having less than 2% cobalt by weight.

2. The control rod drive apparatus of claim 1, wherein the alloy includes less than 0.5% cobalt by weight.

3. The control rod drive apparatus of claim 1, wherein the alloy has a hardness of at least 30 on a hardness Rockwell C (HRC) scale.

4. The control rod drive apparatus of claim 1, wherein the alloy has a melting point of at least 1700 degrees F.

5. The control rod drive apparatus of claim 1, wherein the alloy is nickel-based or iron-based.

6. The control rod drive apparatus of claim 1, wherein the alloy includes boron.

7. The control rod drive apparatus of claim 1, wherein the alloy includes at least 2% silicon by weight.

8. The control rod drive apparatus of claim 1, wherein the alloy is Colmonoy, Nucalloy, Tristelle, or Norem.

9. The control rod drive apparatus of claim 8, wherein the Colmonoy is Colmonoy 5 or Colmonoy 84.

10. The control rod drive apparatus of claim 8, wherein the Nucalloy is Nucalloy 453.

11. The control rod drive apparatus of claim 8, wherein the Tristelle is Tristelle 5183.

12. The control rod drive apparatus of claim 8, wherein the Norem is Norem 2.

13. The control rod drive apparatus of claim 1, further comprising:
a collet assembly within the cylindrical housing structure, the collet assembly surrounding the index tube of the drive assembly, the collet assembly including collet fingers mounted on a collet piston, the collet fingers configured to engage with the index tube.

14. The control rod drive apparatus of claim 13, wherein the collet fingers are made of the alloy having less than 2% cobalt by weight.

15. The control rod drive apparatus of claim 14, wherein the alloy includes less than 0.5% cobalt by weight.
